(19) United States
(12) Patent Application Publication
(10) Pub. No.: US 2026/0237575 A1
(43) Pub. Date: Aug. 13, 2026

(54) RESISTIVE SHEET SLIDE RAIL KEYBOARD SWITCH

(71) Applicant: SHENZHEN SINPH U-LIFE TECHNOLOGY CO., LTD, Shenzhen (CN)

(72) Inventor: Xinhu Xiao, Ji'an (CN)

(21) Appl. No.: 19/637,926

(22) Filed: Apr. 2, 2026

(30) Foreign Application Priority Data
May 26, 2025 (CN) 202521051036.2

(51) Int. Cl. H01H 13/14

(52) U.S. Cl. CPC H01H 13/14

(57) ABSTRACT

The present application discloses a resistive sheet slide rail keyboard switch, including a bottom shell and a top shell arranged on a top of the bottom shell. An accommodating cavity is formed between the bottom shell and the top shell. A press stem is arranged within the accommodating cavity. The top shell is provided with a through hole for a portion of the press stem to pass through. A spring is installed between a bottom of the press stem and the bottom shell. A resistive sheet is installed on a side wall of the press stem. Terminals are installed on the bottom shell at positions corresponding to the resistive sheet. Two terminals are provided and are in contact with the resistive sheet. Connection ends of the terminals penetrate the bottom shell and extend to the exterior. The present application enables one key to control multiple functions.

### CROSS-REFERENCE TO RELATED APPLICATIONS

This application claims priority to Chinese Patent Application No. 202521051036.2, filed on May 26, 2025, which is hereby incorporated by reference in its entirety.

### TECHNICAL FIELD

The present application relates to the technical field of keyboard switches, and specifically to a resistive sheet slide rail keyboard switch.

### BACKGROUND

The keyboard is the most commonly used and primary input device. It allows for the input of English letters, numbers, punctuation marks, and the like into a computer, thereby issuing commands and inputting data. Key switches are an important component of the keyboard, facilitating user operation.

Currently, most keyboard switches on the market have a single function, meaning each key can only transmit one signal. Although magnetic switches are widely used, they are susceptible to electromagnetic interference, leading to unstable signal transmission and affecting user experience. Therefore, the applicant has designed a resistive sheet slide rail keyboard switch, which is capable of transmitting multiple signals and has strong anti-interference capability, to address the aforementioned problems.

### SUMMARY

In view of the deficiencies in the prior art, an objective of the present application is to provide a resistive sheet slide rail keyboard switch, aiming to solve the problems in the prior art that keyboard switches have a single function where each key can only transmit one signal, and that they are susceptible to electromagnetic interference, which leads to unstable signal transmission.

To achieve the above objective, the present application provides the following technical solution:

A resistive sheet slide rail keyboard switch, including a bottom shell and a top shell arranged on a top of the bottom shell, where an accommodating cavity is formed between the bottom shell and the top shell, a press stem is arranged within the accommodating cavity, the top shell is provided with a through hole for a portion of the press stem to pass through, a spring is installed between a bottom of the press stem and the bottom shell, a resistive sheet is installed on a side wall of the press stem, terminals are installed on the bottom shell at positions corresponding to the resistive sheet, two terminals are provided and are in contact with the resistive sheet, and connection ends of the terminals penetrate the bottom shell and extend to the exterior.

As a preferred embodiment of the present application, a pair of resistive sheet fixing posts are fixedly connected to the side wall of the press stem, insertion holes are provided on the resistive sheet at positions corresponding to the resistive sheet fixing posts, and the resistive sheet and the press stem are positioned and installed by passing the resistive sheet fixing posts through the insertion holes.

As a preferred embodiment of the present application, the two terminals are respectively arranged on two sides of the resistive sheet.

As a preferred embodiment of the present application, positioning blocks are fixedly connected around a bottom of the top shell, positioning slots corresponding to positions of the positioning blocks are provided around an outer wall of the bottom shell, and the top shell and the bottom shell are fixed by engaging the positioning blocks into the positioning slots.

As a preferred embodiment of the present application, a fixed sleeve is fixedly connected to an internal bottom end of the bottom shell, an insertion column is fixedly connected to a bottom of the press stem, a bottom end of the insertion column is movably inserted into the fixed sleeve, and the spring is sleeved over an exterior of the fixed sleeve and the insertion column.

As a preferred embodiment of the present application, slide rails are vertically arranged on two sides of the press stem, slide grooves corresponding to positions of the slide rails are provided on an inner wall of the top shell, and the press stem and the top shell are slidably connected via the slide rails and the slide grooves.

Compared with the prior art, the beneficial effects of the present application are as follows:

The present application fixes the resistive sheet to the press stem, with the two terminals respectively contacting two sides of the resistive sheet. Pressing the press stem to move up and down changes a vertical distance between the two terminals and the resistive sheet, thereby causing a corresponding resistance value to be obtained between the two feet of the terminals and transmitted to a keyboard PCB. The keyboard PCB converts the resistance value into a corresponding signal and transmits it to the keyboard MCU. The keyboard MCU can then control various output signals based on the received signal, enabling convenient and quick implementation of multiple function controls with a single key. Compared to magnetic switches, the resistive switch is free from interference by external magnetic and electric fields, has stronger anti-interference capability, and provides more stable signal transmission.

### BRIEF DESCRIPTION OF THE DRAWINGS

FIG. 1 is a schematic overall view of a resistive sheet slide rail keyboard switch.

FIG. 2 is a schematic exploded view of a resistive sheet slide rail keyboard switch.

FIG. 3 is a schematic cross-sectional view of a resistive sheet slide rail keyboard switch.

FIG. 4 is a schematic view showing layout of connection ends of terminals.

FIG. 5 is a schematic view showing another embodiment of installation of a resistive sheet and a press stem.

Description of reference signs: 1 - bottom shell; 101 - fixed sleeve; 102 - positioning slot; 2 - top shell; 201 - slide groove; 202 - positioning block; 3 - press stem; 301 - slide rail; 302 - resistive sheet fixing post; 4 - resistive sheet; 5 - terminal; 6 - spring.

### DESCRIPTION OF EMBODIMENTS

The technical solutions in the embodiments of the present application will be described clearly and completely below in conjunction with the accompanying drawings in the embodiments of the present application. It is apparent that the described embodiments are merely a part of the embodiments of the present application, and not all of them. Based on the embodiments of the present application, all other embodiments obtained by a person of ordinary skill in the art without making creative efforts shall fall within the scope of protection of the present application.

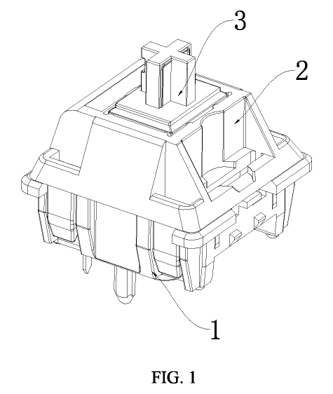

Embodiment: with reference to FIG. 1 to FIG. 5, this embodiment provides a resistive sheet slide rail keyboard switch, which includes a bottom shell 1 and a top shell 2 arranged on a top of the bottom shell 1. An accommodating cavity is formed between the bottom shell 1 and the top shell 2. A press stem 3 is arranged within the accommodating cavity. The top shell 2 is provided with a through hole for a portion of the press stem 3 to pass through. A spring 6 is installed between a bottom of the press stem 3 and the bottom shell 1. A resistive sheet 4 is installed on a side wall of the press stem 3. Terminals 5 are installed on the bottom shell 1 at positions corresponding to the resistive sheet 4. Two terminals 5 are provided and are in contact with the resistive sheet 4. The two terminals 5 are respectively arranged on two sides of the resistive sheet 4. Connection ends of the terminals 5 penetrate the bottom shell 1 and extend to the exterior. The connection ends of the terminals 5 extending to the exterior of the bottom shell 1 serve as pins for connecting to a keyboard PCB. In use, the resistive sheet 4 is fixed to the press stem 3, and the two terminals 5 respectively contact the two sides of the resistive sheet 4. Pressing the press stem 3 to move up and down changes a vertical distance between the two terminals 5 and the resistive sheet 4, thereby causing a corresponding resistance value to be obtained between two feet of the terminals 5 and transmitted to the keyboard PCB. The keyboard PCB converts the resistance value into a corresponding signal and transmits it to a keyboard MCU. The keyboard MCU can control various output signals according to the received signal, enabling convenient and quick implementation of multiple function controls with a single key. Compared to magnetic switches, the resistive switch is free from interference by external magnetic and electric fields, has stronger anti-interference capability, and provides more stable signal transmission.

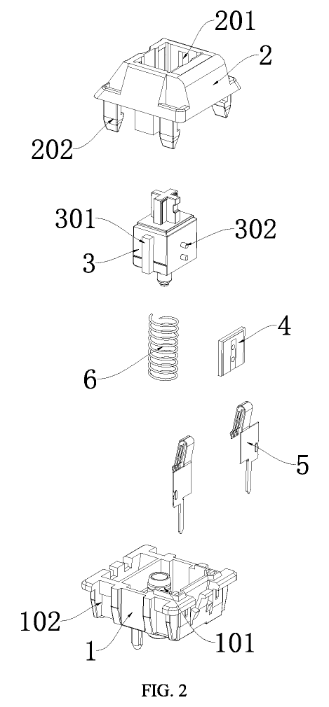

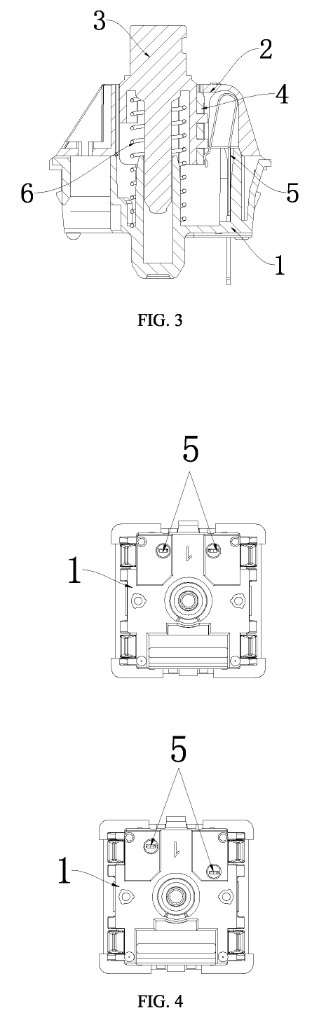

In this embodiment, as shown in FIG. 2 and FIG. 3, a pair of resistive sheet fixing posts 302 are fixedly connected to the side wall of the press stem 3. Insertion holes are provided on the resistive sheet 4 at positions corresponding to the resistive sheet fixing posts 302. The resistive sheet 4 and the press stem 3 are positioned and installed by passing the resistive sheet fixing posts 302 through the insertion holes. When assembling the resistive sheet 4 and the press stem 3, the resistive sheet 4 is aligned so that its insertion holes are fitted over the resistive sheet fixing posts 302 on the press stem 3, thereby achieving aligned assembly of the resistive sheet 4 and the press stem 3 and ensuring the position of the resistive sheet remains unchanged. To enhance the fixing effect, adhesive bonding may also be employed between the resistive sheet 4 and the press stem 3. In other embodiments, as shown in FIG. 5, an interference-fit insertion connection may also be adopted, where a pair of guide rails are provided on the exterior of the press stem 3, and the resistive sheet 4 is inserted and installed between the pair of guide rails to achieve fixation. The key requirement is to achieve a stable assembly of the resistive sheet 4 and the press stem 3. The material of the resistive sheet 4 is a PCB material or plastic material, which possesses good conductivity and stability.

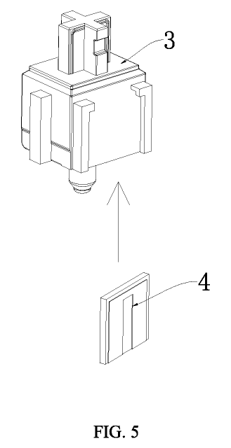

In this embodiment, as shown in FIG. 4, the connection ends of the terminals 5 extending to the exterior of the bottom shell 1, which serve as pins, may have various configurations. The connection ends of the two terminals 5 may be arranged flush with each other or may be staggered, so as to adapt to connections with different keyboard PCBs.

In this embodiment, as shown in FIG. 1 and FIG. 2, positioning blocks 202 are fixedly connected around a bottom of the top shell 2. Positioning slots 102 corresponding to positions of the positioning blocks 202 are provided around an outer wall of the bottom shell 1. The top shell 2 and the bottom shell 1 are fixed by engaging the positioning blocks 202 into the positioning slots 102. The provided positioning blocks 202 and positioning slots 102 facilitate the fixed assembly of the top shell 2 and the bottom shell 1.

In this embodiment, as shown in FIG. 2 and FIG. 3, a fixed sleeve 101 is fixedly connected to an internal bottom end of the bottom shell 1. An insertion column is fixedly connected to a bottom of the press stem 3. A bottom end of the insertion column is movably inserted into the fixed sleeve 101. The spring 6 is sleeved over an exterior of the fixed sleeve 101 and the insertion column. During the process of pressing the press stem 3 to move up and down, the insertion column moves within the fixed sleeve 101, which, on one hand, provides a limiting and guiding function for the press stem 3, and on the other hand, confines the position of the spring 6. The spring 6 provides a restoring force for the press stem 3, ensuring that the press stem 3 can quickly return to its original position after being operated.

In this embodiment, as shown in FIG. 2, slide rails 301 are vertically arranged on two sides of the press stem 3. Slide grooves 201 corresponding to positions of the slide rails 301 are provided on an inner wall of the top shell 2. The slide grooves 201 are designed such that their lower ends extend through to a bottom end face of the top shell 2, while their upper ends do not extend through to a top end face of the top shell 2. The press stem 3 and the top shell 2 are slidably connected via the slide rails 301 and the slide grooves 201. The provided slide rails 301 and slide grooves 201 serve to constrain and guide the press stem 3, ensuring smooth and precise up-and-down movement of the press stem 3 and preventing the press stem 3 from disengaging from the top of the top shell 2.

Working principle: during assembly, first install the two terminals 5 inside the bottom shell 1. Then, align the resistive sheet 4 so that its insertion holes are fitted over the resistive sheet fixing posts 302 on the press stem 3 to install the resistive sheet 4 onto the press stem 3. Next, install the press stem 3 into the interior of the top shell 2 so that the press stem 3 and the top shell 2 are slidably connected via the slide rails 301 and the slide grooves 201. Then, sleeve the spring 6 over the exterior of the fixed sleeve 101. Subsequently, assemble the top shell 2 and the bottom shell 1 by inserting the insertion column on the press stem 3 into the fixed sleeve 101 and then connecting the top shell 2 and the bottom shell 1 by engaging the positioning blocks 202 into the positioning slots 102 for fixation, thereby completing the assembly of the keyboard switch. In use, the resistive sheet 4 is fixed to the press stem 3, and the two terminals 5 respectively contact the two sides of the resistive sheet 4. By pressing the press stem 3 to move up and down, the vertical distance between the two terminals 5 and the resistive sheet 4 is changed, so that a corresponding resistance value is obtained between the two feet of the terminals 5 and transmitted to the keyboard PCB. The keyboard PCB converts the resistance value into a corresponding signal and transmits it to the keyboard MCU. The keyboard MCU can control various output signals according to the received signal, enabling convenient and quick implementation of multiple function controls with a single key. Compared to magnetic switches, the resistive switch is free from interference by external magnetic and electric fields, has stronger anti-interference capability, and provides more stable signal transmission.

The aforementioned embodiments are relatively preferred implementation schemes of the present application. In addition, the present application may also be implemented in other manners. Any obvious substitutions made without departing from the concept of this technical solution shall fall within the scope of protection of the present application.

What is claimed is:

1. A resistive sheet slide rail keyboard switch, comprising a bottom shell and a top shell arranged on a top of the bottom shell , wherein an accommodating cavity is formed between the bottom shell and the top shell , a press stem is arranged within the accommodating cavity, the top shell is provided with a through hole for a portion of the press stem to pass through, a spring is installed between a bottom of the press stem and the bottom shell , a resistive sheet is installed on a side wall of the press stem , terminals are installed on the bottom shell at positions corresponding to the resistive sheet , two terminals are provided and are in contact with the resistive sheet , and connection ends of the terminals penetrate the bottom shell and extend to the exterior.

2. The resistive sheet slide rail keyboard switch according to claim 1, wherein a pair of resistive sheet fixing posts are fixedly connected to the side wall of the press stem , insertion holes are provided on the resistive sheet at positions corresponding to the resistive sheet fixing posts , and the resistive sheet and the press stem are positioned and installed by passing the resistive sheet fixing posts through the insertion holes.

3. The resistive sheet slide rail keyboard switch according to claim 1, wherein the two terminals are respectively arranged on two sides of the resistive sheet .

4. The resistive sheet slide rail keyboard switch according to claim 1, wherein positioning blocks are fixedly connected around a bottom of the top shell, positioning slots corresponding to positions of the positioning blocks are provided around an outer wall of the bottom shell , and the top shell and the bottom shell are fixed by engaging the positioning blocks into the positioning slots .

5. The resistive sheet slide rail keyboard switch according to claim 1, wherein a fixed sleeve is fixedly connected to an internal bottom end of the bottom shell, an insertion column is fixedly connected to a bottom of the press stem, a bottom end of the insertion column is movably inserted into the fixed sleeve, and the spring is sleeved over an exterior of the fixed sleeve and the insertion column.

6. The resistive sheet slide rail keyboard switch according to claim 1, wherein slide rails are vertically arranged on two sides of the press stem , slide grooves corresponding to positions of the slide rails are provided on an inner wall of the top shell , and the press stem and the top shell are slidably connected via the slide rails and the slide grooves .
